(19) United States
(12) Patent Application Publication
(10) Pub. No.: US 2014/0141116 A1
(43) Pub. Date: May 22, 2014

(54) INJECTION MOLD DEVICE AND INJECTION MOLDING MACHINE

(71) Applicant: JNL CORPORATION, Tokyo (JP)

(72) Inventor: Hiroaki Kawasaki, Chiba (JP)

(73) Assignees: JNL Corporation, Tokyo (JP); Century Innovation Corporation, Chosei-gun, Chiba (JP)

(21) Appl. No.: 14/126,286

(22) PCT Filed: Jun. 23, 2011
(86) PCT No.: PCT/JP2011/064445

§ 371 Date: Dec. 13, 2013

(51) Int. Cl. B29C 45/26; B29C 45/42

(52) U.S. Cl. CPC B29C 45/2606; B29C 45/42
USPC 425/542

(57) ABSTRACT

A first protrusion member 12 is provided on two side surfaces of a fixed mold 1 having a first parting surface 11. Moreover, a second protrusion member 22 is provided on side surfaces of a moving mold 2 including a second parting surface 21 having the same shape and size as the first parting surface 11, that is, two side surfaces placed in positions which are not opposed to the first protrusion member 12 when the fixed mold 1 and the moving mold 2 are closed. Consequently, the fixed mold 1 and the moving mold 2 are positioned by fitting the first protrusion member 12 into the side surface of the moving mold 2 and fitting the second protrusion member 22 into the side surface of the fixed mold 1. Consequently, it is not necessary to provide a guide pin in order to carry out the positioning and a size of a device can be reduced correspondingly. Moreover, it is possible to decrease heat capacities of the fixed mold 1 and the moving mold 2 by the reduction in the size, thereby decreasing consumed power required for a temperature control.

### TECHNICAL FIELD

The present invention relates to an injection mold device and an injection molding machine, and more particularly to an injection mold device for manufacturing a resin product by using a fixed mold and a moving mold, and an injection molding machine using the same.

### BACKGROUND ART

Conventionally, an injection molding method is known as any of many molding methods for a resin product which is utilized within the widest range. In order to manufacture the resin product by the injection molding method, an injection molding machine is used. A metallic injection mold is attached to a portion corresponding to a central part of the injection molding machine. A cavity of the metallic injection mold is formed to take a desirable shape so that a resin product (a molded product) taking the desirable shape is formed (for example, see Patent Documents 1 and 2).

### Patent Document 1: Japanese Laid-Open Patent Publication No. 2000-135724

### Patent Document 2: Japanese Laid-Open Patent Publication No. 2007-30441

The metallic injection mold is classified into a two-plate metallic mold (a one-stage sprue metallic mold), a three-plate metallic mold (a two-stage sprue metallic mold) and a hot runner metallic mold (a sprueless metallic mold) depending on a basic structure thereof.

The two-plate metallic mold includes two plates having a moving mold (a male mold) and a fixed mold (a female mold), and a cavity to be a space portion taking an identical shape to a molded product is formed by a convex surface of the male mold and a concave surface of the female mold. The sprue is provided in only a first stage (the fixed mold side) and a molten resin reaches the cavity along the sprue, the runner and a gate from a nozzle of a molding machine. Although the two-plate metallic mold has the simplest structure, it has a disadvantage that a molded product (a product formed by a resin in the cavity) and a runner portion (a part formed by a resin remaining in the sprue, the runner and the gate) are integrally taken out of the metallic mold, and therefore, the runner portion is to be cut out after they are taken out.

The three-plate metallic mold includes three plates having a moving mold (a male mold), a fixed mold (a female mold) and a runner stripper plate. The three-plate metallic mold also has a cavity formed by a convex surface of the male mold and a concave surface of the female mold. The sprue is provided in a first stage (the fixed mold side) and a second stage (the moving mold side), and the molten resin injected from the nozzle of the molding machine passes through the sprue in the first stage and then reaches the cavity through the sprue in the second stage via the runner. Although the three-plate metallic mold has a structure which is more complicated than a structure of the two-plate metallic mold, it has an advantage that the molded product and the runner portion can separately be taken out.

The hot runner metallic mold always heats the sprue portion to be a passage for the molten resin and prevents a resin remaining in the sprue portion from being cooled and solidified. Although the hot runner metallic mold has a complicated structure, the runner portion is not generated. Therefore, it has an advantage that a time and labor required for taking the runner portion out every molding can be eliminated.

FIG. 1 is a view showing an example of a structure of a two-place metallic mold which has the simplest structure. In FIG. 1, 101 denotes a fixed mold and 102 denotes a moving mold, and both of them are constituted by thick plates having square sections. A cavity 103 to be a space portion taking an identical shape to that of a molded product is formed by a concave surface provided on a part of the fixed mold 101 and a convex surface provided on a part of the moving mold 102. 104 denotes a guide pin which is used for positioning the fixed mold 101 and the moving mold 102. Usually, four guide pins 104 are provided in the vicinity of four corners of the fixed mold 101 and the moving mold 102.

105 denotes a fixing side attaching plate which serves to attach the fixed mold 101 to the molding machine (now shown and so forth). 106 denotes a sprue, 107 denotes a runner, and 108 denotes a gate, and a passage for a molten resin is formed by them. The sprue 106 designates a resin passage from a nozzle 100 of the molding machine to the runner 107. The runner 107 designates a resin passage from the sprue 106 to the gate 108. The gate 108 designates an inlet for pouring the molten resin into the cavity 103.

109 denotes a supporting plate and is used for reducing a thickness of the moving mold 102. 110 denotes a spacer block which is a plate for maintaining a necessary space for a pull-out operation to take a molded product out of the cavity 103. 111 denotes a pull-out pin which is used for taking the molded product out of the cavity 103. 112 denotes a return pin which is constituted to be thicker for increasing a strength than the pull-out pin 111. After the molded product is taken out of the cavity 103, the return pin 112 is caused to abut on the fixed mold 101, thereby pushing the pull-out pin 111 back to an original position.

113 denotes an ejector plate to which the pull-out pin 111 is attached. The ejector plate 113 having the pull-out pin 111 attached thereto is pushed out by means of an ejector mechanism (not shown) of the molding machine, thereby taking the molded product out of the cavity 103 by means of the pull-out pin 111. 114 denotes a moving side attaching plate which serves to attach the moving mold 102 to the molding machine. 115 denotes a cooling water hole to be a passage through which cooling water for cooling the metallic mold flows.

The injection molding is carried out by the two-plate metallic mold constituted as described above in order of steps of mold closing, injection, pressure holding, cooling, mold opening and mold releasing. At the mold closing step, a mold closing mechanism (not shown) of the molding machine is operated to press, by a closing force at a predetermined pressure, both the fixed mold 101 attached to the fixing side attaching plate 105 and the moving mold 102 attached to the moving side attaching plate 114.

At the injecting step, a resin molten at a high pressure and high temperature is caused to flow into the metallic mold and the cavity 103 is filled with the molten resin. At the pressure holding step, a pressure is continuously applied to the metallic mold while the molten resin is additionally filled in such a manner that the molten resin is certainly extended into the metallic mold. The pressure to be applied in the pressure holding may be lower than that in the resin filling.

The cooling step is advanced almost simultaneously with the pressure holding step. At the cooling step, the cooling water is caused to flow into the cooling water hole 115 formed in a certain depth from a surface of the metallic mold, thereby cooling the metallic mold to have a certain temperature or less. After the molded product is cooled and sufficiently solidified by the cooling, the moving mold 102 is opened at the mold opening step and the molded product embracing the moving mold 102 at the mold releasing step is pulled out by means of the pull-out pin 111 so that the molded product is taken out.

### DISCLOSURE OF THE INVENTION

As described above, when the molded product is to be manufactured by the conventional metallic injection mold, the resin molten at a high pressure and a high temperature is caused to flow into the metallic mold and the cooling is carried out while the pressure is maintained to be constant. The passage (the sprue 106, the runner 107 or the gate 108) into which the molten resin is caused to flow is thin, and the molten resin is cooled and solidified little by little when it flows through the passage. In order to suppress the solidification of the resin as greatly as possible, it is necessary to cause the molten resin heated to a high temperature to flow into the cavity 103 and to fill the cavity 103 therewith in a short time by an application of a high pressure.

At this time, the pressure of the molten resin to be injected into the metallic mold depends on a viscosity of the resin and is very high in a range of 200 to 500 kgf/cm². In order to prevent the mold opening from being caused even if the high injection pressure is applied to the molten resin, a high pressure is also required for the mold closing. For example, if the injection pressure of the molten resin is 300 kgf/cm² and a projection area in the mold closing direction of the molded product is 1,200 cm², the molten resin having the injection pressure applied thereto tries to open the metallic mold by a great force of 360 Ton. In other words, a closing force requires 360 Ton or more. For this reason, there is a problem in that a large quantity of power is consumed to obtain the injection pressure of the molten resin and the closing pressure of the metallic mold.

When the molten resin flowing through the passage is solidified, moreover, a higher injection pressure is required. For this reason, it is necessary to heat the metallic mold to a high temperature in order to cause the solidification of the resin with difficulty. Therefore, there is a problem in that a large quantity of power is consumed for heating the metallic mold. In addition, the metallic mold is large-sized so that a heat capacity is large. For this reason, the metallic mold cannot be heated to a melting point of the resin so that the solidification of the resin cannot be prevented completely. Also in the case in which the metallic mold is heated, therefore, a high injection pressure is still required so that a large quantity of power is consumed. After the cavity 103 is filled with the molten resin, furthermore, it is necessary to cause the cooling water to flow to the cooling water hole 115, thereby cooling the metallic mold down to a certain temperature. Also in the cooling, there is a problem in that a large quantity of power is consumed.

In order to obtain a rigidity which can be resistant to a high pressure of several hundreds Ton, furthermore, materials of the fixed mold 101 and the moving mold 102 are set to be alloys using steel materials and their thicknesses are also to be increased. Consequently, there are required the fixing side attaching plate 105 and the moving side attaching plate 114 which are large. Moreover, it is necessary to provide the guide pin 104 in order to position the fixed mold 101 and the moving mold 102 and to provide the spacer block 110, the pull-out pin 111, the return pin 112 and the ejector plate 113 in order to take the molded product out. In order to install them, it is also necessary to increase widths of the fixed mold 101 and the moving mold 102.

For this reason, there is a problem in that the whole metallic mold is much larger than the molded product and a large space is required for the installation. In general, a volume ratio of the metallic mold to the molded product is approximately 300 to 2,000 and a weight ratio is approximately 2,000 to 10,000. In the related art, thus, it is necessary to use a mold which is several hundred to several thousand times as large as a molded product to be fabricated. Consequently, it is apparent that a waste of an installation space is very great. Moreover, a pressure control and a temperature control are to be carried out for such a large and heavy metallic mold. Therefore, a waste of consumed power is also immeasurable.

A large number of patent applications devise to lessen the waste of the consumed power, the installation space or the like in the metallic mold. However, most of the inventions found in the patent applications relate to an improvement on a certain level which is obtained by following a basic structure of the metallic mold shown in FIG. 1, and an extent of the improvement in the waste is insufficient. In order to considerably reduce the waste described above, it is necessary to fundamentally reconsider the structure of the metallic mold.

The present invention has been made to solve these problems and has an object to enable a considerable reduction in a size of an injection mold device and to enable a sharp decrease in power consumed by serial injection molding.

In order to solve the problems, the injection mold device according to the present invention includes at least one of a first protrusion member which is provided on a side surface of a fixed mold having a first parting surface and is protruded toward a moving mold side more greatly than the first parting surface and a second protrusion member which is provided on a side surface of the moving mold having a second parting surface which has the same shape and size as the first parting surface and is protruded toward the fixed mold side more greatly than the second parting surface.

According to the present invention which is thus constituted, the fixed mold and the moving mold are positioned by at least one of fitting of the first protrusion member which is protruded toward the moving mold side more greatly than the first parting surface into the side surface of the moving mold and fitting of the second protrusion member which is protruded toward the fixed mold side more greatly than the second parting surface with the side surface of the fixed mold. Therefore, it is not necessary to provide the guide pin in order to carry out the positioning. Consequently, a guide pin does not need to be provided so that widths of the fixed mold and the moving mold can be reduced correspondingly. As a result, it is possible to wholly reduce a size of the injection mold device.

When the sizes of the fixed mold and the moving mold are reduced, moreover, a heat capacity is decreased. Therefore, it is possible to implement heating for the fixed mold and the moving mold which is to be carried out to cause the solidification of a resin with difficulty at an injecting step and cooling for the fixed mold and the moving mold which is to be carried out at a cooling step with a smaller energy than that in the related art. Consequently, it is possible to reduce consumed power required for a temperature control at the injecting step and the cooling step.

According to another aspect of the present invention, a sprue from a nozzle of a molding machine to a cavity is formed in the fixed mold as a passage for a molten resin.

According to another feature of the present invention which is thus constituted, a runner is eliminated in the passage from the nozzle of the molding machine to the cavity. Consequently, it is possible to shorten the passage as compared with the related art. Therefore, it is possible to cause the solidification of the molten resin over the passage with difficulty so that it is possible to reduce an injection pressure to be applied to the molten resin.

Consequently, it is possible to implement the pressurization for the molten resin which is to be carried out at the injecting step with a smaller energy than that in the related art. Thus, it is possible to reduce consumed power required for a pressure control at the injecting step. When the injection pressure can be lowered, moreover, a pressure required for mold closing can also be reduced. Therefore, it is also possible to reduce consumed power required for obtaining a mold closing pressure.

When the injection pressure can be lowered, furthermore, it is possible to decrease thicknesses of the fixed mold and the moving mold which are intended for a pressure resistance. In other words, it is possible to reduce the widths of the fixed mold and the moving mold by omitting the guide pin as described above and to also decrease the thicknesses of the fixed mold and the moving mold. As a result, the heat capacities of the fixed mold and the moving mold are further reduced. Therefore, it is possible to implement the heating at the injecting step and the cooling at the cooling step with a further smaller energy. By decreasing the thicknesses of the fixed mold and the moving mold, consequently, it is possible to wholly reduce the size of the injection mold device and to further reduce the consumed power required for the temperature control.

According to a further aspect of the present invention, the fixed mold and the moving mold are constituted by a high heat conductivity material, while a bush is provided around the sprue in the fixed mold and is constituted by a low heat conductivity material.

According to a further aspect of the present invention, moreover, the fixed mold and the moving mold are constituted by a low heat conductivity material, while a cooling water hole is provided around a cavity and peripheries of the cavity and the cooling water hole are constituted by a high heat conductivity material.

According to a further feature of the present invention which is thus constituted, when the molten resin flows through the sprue, heat is taken, with difficulty, by the low heat conductivity material formed therearound so that a progress of the resin solidification can be delayed. Consequently, it is possible to further reduce the injection pressure. Therefore, it is possible to further reduce the consumed power required for the pressure control at the injecting step. Consequently, it is also possible to further reduce the pressure required for the mold closing. Therefore, it is also possible to further reduce the consumed power required for obtaining the mold closing pressure.

Since it is possible to further reduce the injection pressure, it is possible to further reduce the thicknesses of the fixed mold and the moving mold which are intended for a pressure resistance. As a result, the heat capacities of the fixed mold and the moving mold are further reduced. Therefore, it is possible to implement the heating at the injecting step and the cooling at the cooling step with a further smaller energy. By further reducing the thicknesses of the fixed mold and the moving mold, consequently, it is possible to further reduce the size of the whole injection mold device and to further reduce the consumed power required for the temperature control.

According to a further aspect of the present invention, there is provided a take-out mechanism for taking out a molded product embracing the cavity of the fixed mold through an adsorption.

According to a further feature of the present invention, moreover, the fixed mold is directly attached to a fixing side attaching plate, and furthermore, the moving mold is directly attached to a moving side attaching plate. Alternatively, the fixed mold is directly attached to the fixing side attaching plate, and furthermore, the moving mold is attached to the moving side attaching plate through an adaptor functioning as a mount.

According to a further feature of the present invention which is thus constituted, there is employed a structure for taking a molded product out through means which is not pulled out. Therefore, it is not necessary to provide a pull-out pin for taking out a molded product embracing the moving mold, a return pin, an ejector plate and a spacer block which are related material thereto, and the like as in the related art. These members do not need to be provided, and correspondingly, the widths of the fixed mold and the moving mold can further be reduced. Consequently, it is also possible to further reduce the size of the whole injection mold device.

When the sizes of the fixed mold and the moving mold are further reduced, moreover, the heat capacity can be decreased more greatly. Therefore, it is possible to implement the heating at the injecting step and the cooling at the cooling step with a further smaller energy. Consequently, it is possible to further reduce the consumed power required for the temperature control at the injecting step and the cooling step.

### BRIEF DESCRIPTION OF THE DRAWINGS

FIG. 1 is a view showing an example of a structure of a conventional two-plate metallic mold.

FIG. 2 is a view showing an example of a structure of an injection mold device according to the present embodiment.

FIG. 3 is a view showing an example of a structure of an injection molding machine using the injection mold device according to the present embodiment.

FIG. 4 is a view showing a variant of a first protrusion member and a second protrusion member according to the present embodiment.

FIG. 5 is a view showing a variant of the injection molding machine using the injection mold device according to the present embodiment.

FIG. 6 is a view showing a variant of a take-out mechanism to be used for the injection mold device according to the present embodiment.

FIG. 7 is a view showing a variant of a resin passage to be used for the injection mold device according to the present embodiment.

### BEST MODE FOR CARRYING OUT THE INVENTION

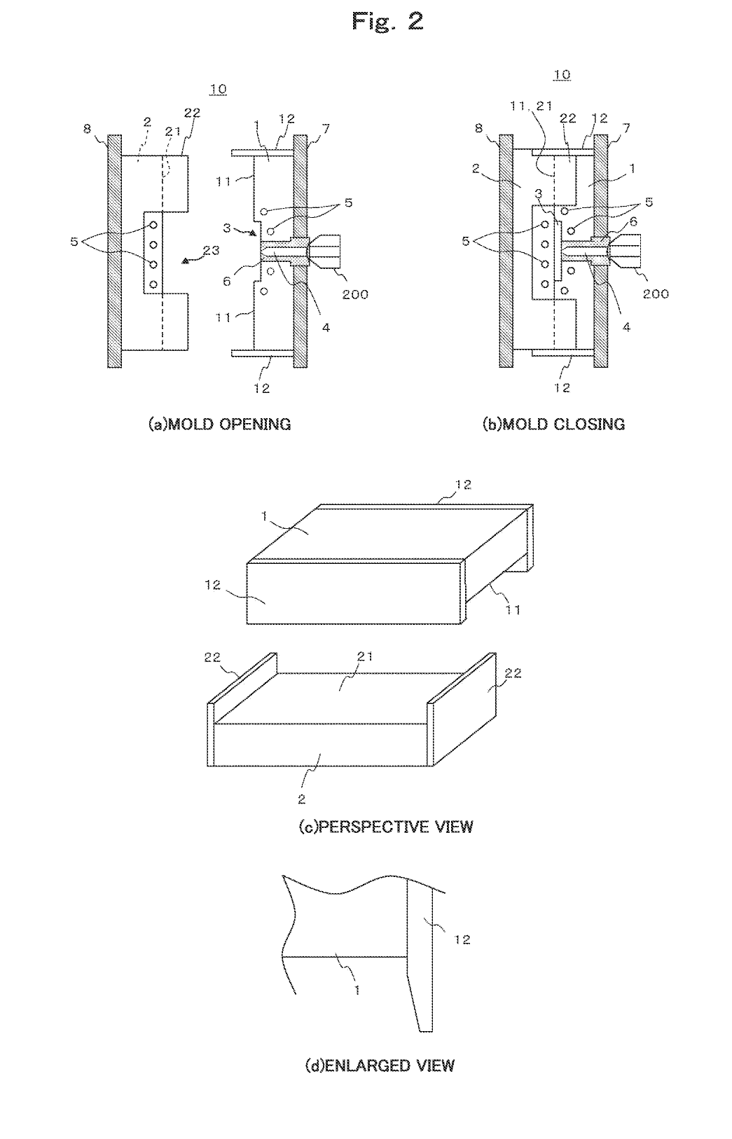

An embodiment according to the present invention will be described below with reference to the drawings. FIG. 2 is a view showing an example of a structure of an injection mold device 10 according to the present embodiment. FIG. 2 (a) shows a state in which mold opening is carried out and FIG. 2 (b) shows a state in which mold closing is carried out. Moreover, FIG. 2 (c) is a perspective view simply illustrating a main part of an injection mold device 10. Furthermore, FIG. 2(d) is a partially enlarged view showing a protrusion member.

In FIG. 2, a fixed mold 1 is a plate having a square section, for example, and a surface thereof has a first parting surface 11 which is flat. A moving mold 2 is also a plate having a square section, for example, and a surface thereof has a second parting surface 21 which is opposed to the first parting surface 11 and is flat. The first parting surface 11 and the second parting surface 21 have the same shape and size, and are formed to be fitted all over the surface (excluding a portion of a cavity 3) when the fixed mold 1 and the moving mold 2 are closed.

A first protrusion member 12 protruded toward the moving mold 2 side more greatly than the first parting surface 11 is provided on a part of side surfaces of the fixed mold 1. In the present embodiment, the first protrusion member 12 is provided on two of four side surfaces possessed by the fixed mold 1 which are positioned on a set of opposite sides of a square forming the first parting surface 11. The first protrusion member 12 is a square plate which wholly covers a single side surface and has a portion protruded toward the moving mold 2 side. A tapered inclination is formed on an inside of the protruded portion as shown in FIG. 2 (d). The first protrusion member 12 is fixed to two side surfaces of the fixed mold 1 with a screw, for example.

A second protrusion member 22 protruded toward the fixed mold 1 side more greatly than the second parting surface 21 is provided on a part of side surfaces of the moving mold 2. In the present embodiment, the second protrusion member 22 is provided on two of four side surfaces possessed by the moving mold 2 in positions which are not opposed to the first protrusion member 21 when the fixed mold 1 and the moving mold 2 are closed. In other words, the second protrusion member 22 is provided on a set of opposite sides in a square forming the second parting surface 21, that is, two side surfaces positioned at different opposite sides from the opposite sides on which the first protrusion member 12 is provided.

The second protrusion member 22 is a square plate which covers a single side surface almost wholly (a whole part excluding a portion of a cooling water hole 5 which will be described below) and has a portion protruded toward the fixed mold 1 side. The same taper inclination as that in FIG. 2(d) is also formed on an inside of the protruded portion of the second protrusion member 22. The second protrusion member 22 is also fixed to the two side surfaces of the moving mold 2 with a screw, for example. The tapered inclination is formed on the inside of the protruded portion of the first protrusion member 12 and the inside of the protruded portion of the second protrusion member 22 so that the positions of the fixed mold 1 and the moving mold 2 are guided by the taper so as to be accurately adapted to each other when mold closing is carried out.

3 denotes a cavity which is formed by providing a concave portion on the first parting surface 11. In the case of the example in FIG. 2, a spatial shape of the concave portion itself represents a shape of the cavity 3 so that a shape of a molded product is obtained. Accordingly, the spatial shape of the concave portion constituting the cavity 3 can be set to be a desirable shape in conformity to the shape of the molded product.

4 denotes a sprue provided in the fixed mold 1 by which a passage for a molten resin from a nozzle 200 of a molding machine (not shown and so forth) to the cavity 3 is formed. A gate is provided on a tip at the cavity 3 side of the sprue 4. In the present embodiment, a runner is not provided between the sprue 4 and the cavity 3. In other words, the molten resin injected from the nozzle 200 of the molding machine directly reaches the cavity 3 via the sprue 4.

5 denotes a cooling water hole which is provided on both the fixed mold 1 and the moving mold 2. The cooling water hole 5 is a passage through which cooling water for cooling the fixed mold 1 and the moving mold 2 flows. The fixed mold 1 and the moving mold 2 are cooled to cool and solidify the molten resin filled in the cavity 3. Accordingly, it is preferable that the cooling water hole 5 should be provided around the cavity 3 in the fixed mold 1 in order to enhance the cooling effect. In the moving mold 2, moreover, it is preferable that the cooling water hole 5 should be provided on the convex portion which is the closest to the cavity 3 when the mold closing is carried out as shown in FIG. 2 (b). In order to enhance a heat conduct ion from the cooling water hole 5 to the cavity 3, furthermore, it is preferable that the fixed mold 1 and the moving mold 2 should be constituted by a steel material having a high heat conductivity, or the like.

As shown in FIGS. 2(a) and 2(b), a notch portion 23 is provided on the second protrusion member 22 in order to prevent the cooling water hole 5 on the fixed mold 2 side and the cooling water hole 5 on the moving mold 2 side from being covered and closed. In FIG. 2 (c), only an arrangement relationship between the first protrusion member 12 and the second protrusion member 22 is simply shown. Therefore, the notch portion 23 is not shown.

6 denotes a bush which is formed around the sprue 4 and is constituted by a material having a lower heat conductivity (for example, ceramic) than the steel material. In the present embodiment, the bush 6 is formed to cover the periphery of the sprue 4. It is also possible to use a material other than ceramic if the material has a lower heat conductivity than the steel material to be used for the fixed mold 1 and the moving mold 2.

In the case in which the bush 6 is thus constituted, a heat is taken from the molten resin flowing through the sprue 4 to the bush 6 with difficulty at the injecting step so that the progress of the resin solidification in the sprue 4 can be delayed because the bush 6 has a low heat conductivity. Moreover, a cool temperature obtained by the cooling water is transferred to the bush 6 with difficulty also at the cooling step. Consequently, the molten resin remaining in the sprue 4 can be maintained at a comparatively high temperature.

7 denotes a fixing side attaching plate which serves to attach the fixed mold 1 to the molding machine. 8 denotes a moving side attaching plate which serves to attach the moving mold 2 to the molding machine. In the present embodiment, there is not employed a structure in which the moving mold 2 is attached to the moving side attaching plate 8 through a supporting plate and a spacer block but a structure in which the moving mold 2 is directly attached to the moving side attaching plate 8.

When the fixed mold 1 is to be attached to the fixing side attaching plate 7 and the moving mold 2 is to be attached to the moving side attaching plate 8, mold closing is carried out in a state in which the fixed mold 1 is first fixed in alignment with a center of a sprue hole and a center of a nozzle hole of the fixing side attaching plate 7 and the moving mold 2 is temporarily fixed to the moving side attaching plate 8. At this time, the first protrusion member 12 protruded toward the moving mold 2 side more greatly than the first parting surface 11 is fitted into the side surface of the moving mold 2, and furthermore, the second protrusion member 22 protruded toward the fixed mold 1 side more greatly than the second parting surface 21 is fitted into the side surface of the fixed mold 1 so that the fixed mold 1 and the moving mold 2 are positioned.

In other words, two first protrusion members 12 provided on the opposite side surfaces of the fixed mold 1 are fitted into two side surfaces (where the second protrusion member 22 is not provided) of the moving mold 2 which are opposite to each other. Consequently, the fixed mold 1 and the moving mold 2 are positioned with respect to a first direction in which the two first protrusion members 12 are opposed to each other.

At the same time, two second protrusion members 22 provided on the opposite side surfaces of the moving mold 2 are fitted into two side surfaces (where the first protrusion member 12 is not provided) of the fixed mold 1 which are opposite to each other. Consequently, the fixed mold 1 and the moving mold 2 are positioned with respect to a second direction (a perpendicular direction to the first direction) in which the two second protrusion members 22 are opposed to each other.

When the fixed mold 1 and the moving mold 2 are thus positioned, the moving mold 2 is really fixed to the moving side attaching plate 8.

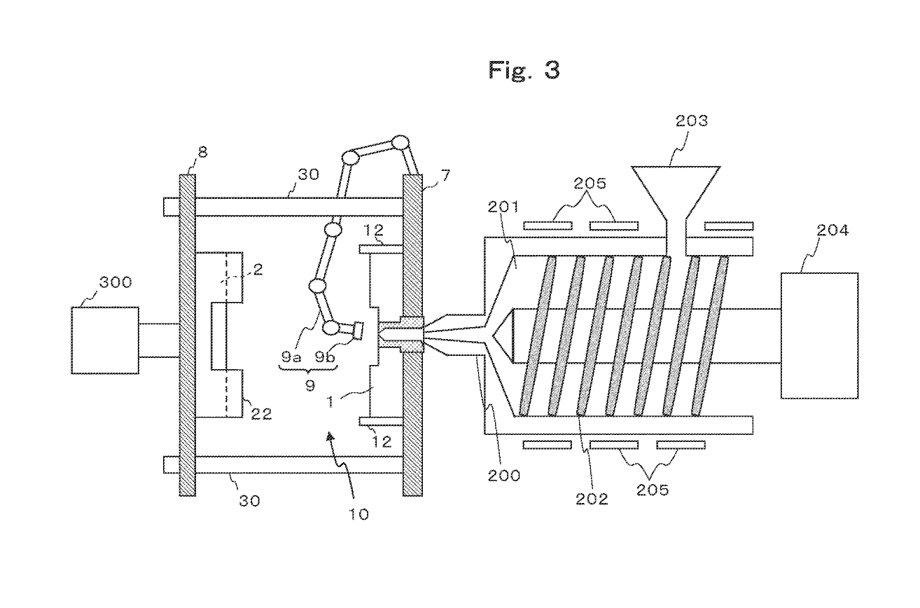

FIG. 3 is a view showing an example of a structure of an injection molding machine using the injection mold device 10 having the structure described above. In FIG. 3, components having the same functions as the components shown in FIG. 2 have the same reference numerals. Since the structure of the injection mold device 10 has already been described in detail, moreover, a part is not shown for simplicity.

In FIG. 3, 9 denotes a take-out mechanism which serves to take out a molded product embracing the cavity 3 of the fixed mold 1 by an adsorption. In the present embodiment, the take-out mechanism 9 is constituted by an arm 9a having a plurality of joints and an adsorption pad 9b provided on a tip of the arm 9a, and serves to take the molded product out of the cavity 3 by a vacuum adsorption, for example.

30 denotes a tie bar which has one of end sides fixed to the fixing side attaching plate 7 and the other end side inserted in a hole provided on the moving side attaching plate 8. The tie bar 30 serves as a guide for guiding a path for a movement of the moving mold 2 together with the moving side attaching plate 8 in the movement. 300 denotes a hydraulic cylinder which serves to control the movement of the moving side attaching plate 8 (and the moving mold 2 attached thereto).

201 denotes a cylinder of a molding machine, 202 denotes a screw, 203 denotes a hopper, 204 denotes a hydraulic motor, and 205 denotes a heater. A raw resin put from the hopper 203 is heated by the heater 205 in the cylinder 201, and furthermore, is kneaded by the screw 202 and is injected from the nozzle 200 provided on a tip of the cylinder 201 toward the injection mold device 10.

Next, description will be given to an operation of the injection mold device 10 according to the present embodiment which is constituted as described above. The injection molding is also carried out by the injection mold device 10 according to the present embodiment in order of the steps of mold closing, injection, pressure holding, cooling, mold opening and mold releasing in the same manner as in the related art.

At the first mold closing step, the hydraulic cylinder 300 of the molding machine is operated to move the moving side attaching plate 8 and the moving mold 2 attached thereto in a direction of the fixing mold 1, thereby mold closing both the fixed mold 1 and the moving mold 2 at a predetermined pressure. At this time, the take-out mechanism 9 is retreated. When the fixed mold 1 and the moving mold 2 are closed, the first parting surface 11 and the second parting surface 21 are fitted into to each other as shown in FIG. 2(b).

At this time, the first protrusion member 12 protruded toward the moving mold 2 side more greatly than the first parting surface 11 is fitted into the side surface of the moving mold 2 and the second protrusion member 22 protruded toward the fixed mold 1 side more greatly than the second parting surface 21 is fitted into the side surface of the fixed mold 1. Consequently, the fixed mold 1 and the moving mold 2 are positioned.

At the injecting step, the resin molten in the cylinder 201 of the molding machine is caused to flow into the injection mold device 10 and the cavity 3 is filled with the molten resin. At the pressure holding step, a pressure is continuously applied to the injection mold device 10 while the molten resin is additionally filled in such a manner that the cavity 3 is reliably filled with the molten resin. The pressure to be applied in the pressure holding may be lower than a pressure in the resin filling. The cooling step progresses almost simultaneously with the pressure holding step. At the cooling step, cooling water is caused to flow to the cooling water hole 5, thereby cooling the fixed mold 1 and the moving mold 2 to have a certain temperature or less.

After the molten resin is cooled and is sufficiently solidified as a molded product in the cavity 3, the hydraulic cylinder 300 is operated in a reverse direction to move the moving mold 2 in such a direction as to separate from the fixed mold 1 at the mold opening step. At the mold releasing step, then, the arm 9a of the take-out mechanism 9 is moved to a space formed between the fixed mold 1 and the moving mold 2, thereby adsorbing the molded product embracing the fixed mold 1 to the adsorbing pad 9b and taking it out. Although the resin (the molded product) in the cavity 3 is sufficiently solidified by cooling, the molten resin remaining in the sprue 4 is maintained at a comparatively high temperature. Moreover, the tip of the sprue 4 has a gate structure. Therefore, only the molded product in the cavity 3 can be cut off and taken out of the resin in the sprue 4.

As described above in detail, in the injection mold device 10 according to the present embodiment, the two side surfaces of the fixed mold 1 having the first parting surface 11 are provided with the first protrusion member 12 which is protruded toward the moving mold 2 side more greatly than the first parting surface 11. Moreover, the second protrusion member 22 which is protruded toward the fixed mold 1 side more greatly than the second parting surface 21 is provided on side surfaces of the moving mold 2 including the second parting surface 21 having the same shape and size as the first parting surface 11, that is, two side surfaces placed in positions which are not opposed to the first protrusion member 12 when the fixed mold 1 and the moving mold 2 are closed.

According to the injection mold device 10 in accordance with the present embodiment which is thus constituted, the fixed mold 1 and the moving mold 2 are positioned by fitting the first protrusion member 12 protruded toward the moving mold 2 side more greatly than the first parting surface 11 into the side surface of the moving mold 2 and fitting the second protrusion member 22 protruded toward the fixed mold 1 side more greatly than the second parting surface 21 into the side surface of the fixed mold 1. Therefore, it is not necessary to provide a guide pin for the poisoning. Since the guide pin does not need to be provided, it is possible to correspondingly reduce the widths of the fixed mold 1 and the moving mold 2.

In the injection mold device 10 according to the present embodiment, moreover, the molded product embracing the cavity 3 of the fixed mold 1 is taken out through the adsorption by using the take-out mechanism 9. In order to take the molded product out of the metallic mold by using a pull-out pin provided on the moving mold side. conventionally, a structure for increasing an embracing force for the moving mold to be greater than the fixed mold is employed to cause the molded product to embrace the moving mold, for example. On the other hand, in the present embodiment, the structure for causing the molded product to embrace the moving mold dare not to be employed but the molded product is caused to embrace the fixed mold 1. The molded product embracing the fixed mold 1 is taken out by an adsorption.

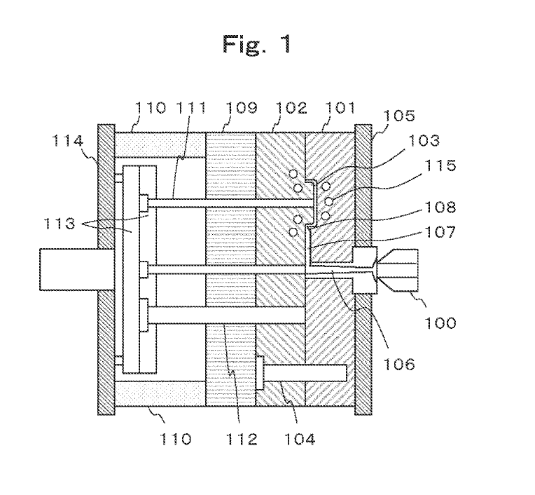

For this reason, it is not necessary to provide the pull-out pin 11 for taking out the molded product embracing the moving mold 102, the return pin 112, the ejector plate 113 and the spacer block 110 which are related members thereto, and the like as in the conventional example shown in FIG. 1. Since these members do not need to be provided, accordingly, it is possible to correspondingly reduce the widths of the fixed mold 1 and the moving mold 2. From the foregoing, it is possible to wholly reduce the size and weight of the injection mold device 10.

When the sizes of the fixed mold 1 and the moving mold 2 can be reduced, a heat capacity is decreased. Therefore, it is possible to implement heating for the fixed mold 1 and the moving mold 2 which is to be carried out to cause the solidification of the resin with difficulty at the injecting step and cooling for the fixed mold 1 and the moving mold 2 which is to be carried out at the cooling step with a smaller energy than that in the related art. Consequently, it is possible to reduce consumed power required for the temperature control at the injecting step and the cooling step.

In the injection mold device 10 according to the present embodiment, moreover, the sprue 4 is formed in the fixed mold 1 as the passage along which the molten resin injected from the nozzle 200 of the molding machine reaches the cavity 3. According to this structure, a runner is eliminated in the passage from the nozzle 200 of the molding machine to the cavity 3. Consequently, it is possible to shorten the passage as compared with the related art. Therefore, it is possible to cause the solidification of the molten resin over the passage with difficulty so that it is possible to reduce an injection pressure to be applied to the molten resin.

In the injection mold device 10 according to the present embodiment, furthermore, the bush 6 is provided around the sprue 4 and is constituted by a low heat conductivity material such as ceramic. For this reason, when the molten resin flows through the sprue 4, heat is taken, with difficulty, by the bush 6 formed therearound so that a progress of the resin solidification can be delayed. Consequently, it is possible to further reduce the injection pressure to be applied to the molten resin.

Thus, it is possible to implement, with a smaller energy than that in the related art, the pressurization for the molten resin which is to be carried out at the injecting step, thereby reducing consumed power required for the pressure control at the injecting step. When the injection pressure can be lowered, moreover, a pressure required for mold closing can also be reduced. Therefore, it is also possible to reduce the consumed power required for obtaining a mold closing pressure.

When the injection pressure can be lowered, moreover, it is possible to reduce the thicknesses of the fixed mold 1 and the moving mold 2 which are intended for a pressure resistance. In other words, it is possible to reduce the widths of the fixed mold 1 and the moving mold 2 by omitting the guide pin, the pull-out pin and the like as described above and to also reduce the thicknesses of the fixed mold 1 and the moving mold 2. As a result, the heat capacities of the fixed mold 1 and the moving mold 2 are further reduced. Therefore, it is possible to implement the heating at the injecting step and the cooling at the cooling step with a further smaller energy. By reducing the thicknesses of the fixed mold 1 and the moving mold 2, consequently, it is possible to wholly reduce the size and weight of the injection mold device 10 by decreasing the thicknesses of the fixed mold 1 and the moving mold 2 and to further reduce the consumed power required for the temperature control.

According to the injection mold device 10 in accordance with the present embodiment which has the structure described above, it is possible to reduce the size so as to have a volume and a weight which are one-several tenth or less as compared with the conventional metallic mold. With the reduction in the size of the injection mold device 10, it is also possible to reduce the size of the whole injection molding machine using the same as a central part. Consequently, it is possible to considerably reduce a waste of an installation space in a factory, thereby cutting down an area of the factory.

According to the injection mold device 10 in accordance with the present embodiment, moreover, it is possible to reduce the consumed power required for the pressure control and the temperature control into one-several tenth or less as compared with the conventional metallic mold. Consequently, it is possible to considerably reduce a waste of the consumed power, thereby decreasing a quantity of CO exhaust considerably.

Although the first parting surface 11 of the fixed mold 1 and the second parting surface 21 of the moving mold 2 take flat shapes in the embodiment, the present invention is not restricted thereto. If the first parting surface 11 and the second parting surface 21 are exactly fitted into each other when mold closing is carried out, the shapes are optional. In consideration of easiness of a processing or the like, it is preferable to take the flat shapes.

Although the description has been given to the example in which the concave portion is provided on the first parting surface 11 of the fixed mold 1 to form the cavity 3 in the embodiment, moreover, the present invention is not restricted thereto. For example, the concave portion may be provided on the second parting surface 21 of the moving mold 2 to form the cavity 3 or the concave portion may be provided on both the first parting surface 11 and the second parting surface 21 to form the cavity 3. Alternatively, the concave portion may be provided on the first parting surface 11 and the convex portion may be provided on the second parting surface 21 to form the cavity 3 through a space formed between the concave portion and the convex portion by mold closing.

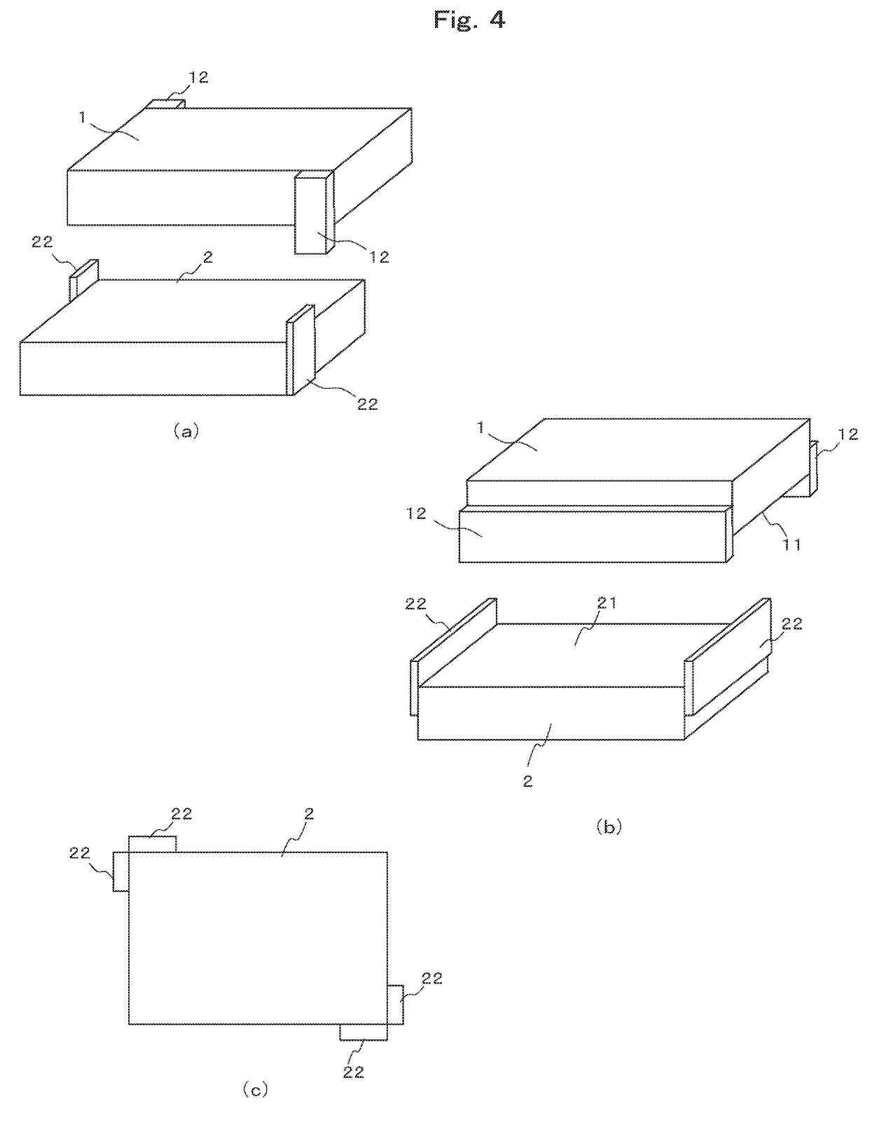

Although the description has been given to the example in which the first protrusion member 12 is provided all over the single side surface of the fixed mold 1 in the embodiment, moreover, the present invention is not restricted thereto. For example, as shown in FIG. 4(a) or 4(b), the first protrusion member 12 may be provided on a part of the single side surface of the fixed mold 1. Similarly, the second protrusion member 22 may be provided on a part of the single side surface of the moving mold 2.

In the case in which the first protrusion member 12 and the second protrusion member 22 are collectively provided in two corner portions as shown in FIG. 4 (a), it is preferable that the first protrusion member 12 and the second protrusion member 22 should have a certain width or more (for example, ½ of the widths of the side surfaces of the fixed mold 1 and the moving mold 2 or more) in order to prevent the positions of the fixed mold 1 and the moving mold 2 from being shifted in two corner portions in which these protrusion members 12 and 22 are not provided. Although the single first protrusion member 12 or second protrusion member 22 is provided on the single side surface in FIG. 4(a), moreover, the first protrusion members 12 or the second protrusion members 22 may be provided on the single side surface.

With the structure in which the second protrusion member 22 is provided on a part of the single side surface of the moving mold 2, thus, it is possible to dispose the second protrusion member 22 by keeping away from the cooling water holes 5 on the fixed mold 1 side and the moving mold 2 side even if the notch portion 23 shown in FIG. 2 (a) is not processed. Since the notch portion 23 is not required, the second protrusion member 22 can easily be processed.

Although the description has been given to the example in which the first protrusion member 12 and the second protrusion member 22 are provided on both the side surface of the fixed mold 1 and the side surface of the moving mold 2 in the embodiment, moreover, the first protrusion member 12 or the second protrusion member 22 may be provided on only one of the side surface of the fixed mold 1 and the side surface of the moving mold 2. For example, FIG. 4(c) is a plan view showing a state in which the second protrusion members 22 are provided on only the side surface of the second protrusion member 22. It is preferable that the protrusion member should be provided on all of the side surfaces in the case in which the protrusion member is provided on either the side surface of the fixed mold 1 or the side surface of the moving mold 2.

Although the description has been given to the example in which the first protrusion member 12 and the second protrusion member 22 are constituted by square plates in the embodiment, moreover, the present invention is not restricted thereto. If the first protrusion member 12 is fitted into the side surface of the moving mold 2 and the second protrusion member 22 is fitted into the side surface of the fixed mold 1, the shapes of the first protrusion member 12 and the second protrusion member 22 are optional.

Although the description has been given to the example in which the fixed mold 1 and the moving mold 2 are constituted by the plates having square sections in the embodiment, furthermore, the present invention is not restricted thereto. In other words, the shapes of the first parting surface 11 and the second parting surface 21 are not restricted to be square.

For example, the fixed mold 1 and the moving mold 2 may be constituted by plates having hexagonal sections and the shapes of the first parting surface 11 and the second parting surface 21 may be hexagonal. In this case, the first protrusion members 12 are provided on three side surfaces where three of the hexagonal sides constituting the first parting surface 11 which are not adjacent to each other are positioned, for example. Moreover, the second protrusion members 22 are provided on three side surfaces where three of the hexagonal sides constituting the second parting surface 21 which are not adjacent to each other, that is, sides which are not opposed to the first protrusion members 12 are positioned. In the same case, the first parting surface 11 and the second parting surface 21 are constituted by other polygons having even-numbered sides.

In addition, the fixed mold 1 and the moving mold 2 may be constituted by plates having pentagonal sections and the shapes of the first parting surface 11 and the second parting surface 21 may be pentagonal. In this case, the first protrusion members 12 are provided on two side surfaces where two of the pentagonal sides constituting the first parting surface 11 which are not adjacent to each other are positioned, for example. Moreover, the second protrusion members 22 are provided on three side surfaces where any of the sides of the pentagon constituting the second parting surface 21 which is not opposed to the first protrusion members 12 are positioned. In the same case, the first parting surface 11 and the second parting surface 21 are constituted by other polygons having odd-numbered sides.

Moreover, the fixed mold 1 and the moving mold 2 may be constituted by plates having circular sections and the shapes of the first parting surface 11 and the second parting surface 21 may be circular. In this case, the first protrusion members 12 are provided on two side surfaces corresponding to two circular arcs (for example, a circular arc having a central angle of 90 degrees) placed in opposed positions to each other with a center of a circle interposed therebetween in a circumference constituting the first parting surface 11. Moreover, the second protrusion members 22 are provided on two side surfaces corresponding to a circular arc (for example, a circular arc having a central angle of 90 degrees) placed in a position which is not opposed to the first protrusion members 12 in a circumference constituting the second parting surface 21.

It is necessary to carry out a many-sided processing in order to cut a plate having a polygonal section out of a large plate material, while a three-face processing is enough for cutting a plate having a circular section out of a cylindrical material. Therefore, there is an advantage that a processing can easily be carried out and a cost can be cut down. In the case in which the fixed mold 1 and the moving mold 2 take cylindrical shapes, the shapes of the first protrusion member 12 and the second protrusion member 22 to be attached to the side surfaces may be constituted by a curved surface material having a curve along the circular arc and may be constituted by a refraction material which can easily be processed (for example, a material obtained by bending a plane material like a hook).

Although the description has been given to the example in which the first protrusion member 12 is fixed to the side surface of the fixed mold 1 with the screw and the second protrusion member 22 is fixed to the side surface of the moving mold 2 with the screw in the embodiment, moreover, the present invention is not restricted thereto. For example, they may be fixed with means other than the screw. Furthermore, the first protrusion member 12 and the fixed mold 1, and the second protrusion member 22 and the moving mold 2 may be formed integrally, respectively. However, it is preferable that the first protrusion member 12 and the fixed mold 1, and the second protrusion member 22 and the moving mold 2 should be fixed separately from each other by some means in respect of easiness of the processing.

Although the description has been given to the example (FIG. 3) in which the small-sized injection mold device 10 is used in the small-sized molding machine in the embodiment, moreover, the present invention is not restricted thereto. At present, a large-sized metallic injection mold is used in a large-sized molding machine in every factory. However, it might be hard to replace the large-sized metallic mold with the small-sized injection mold device 10, and at the same time, to replace the large-sized molding machine with the small-sized molding machine in respect of a burden on a cost.

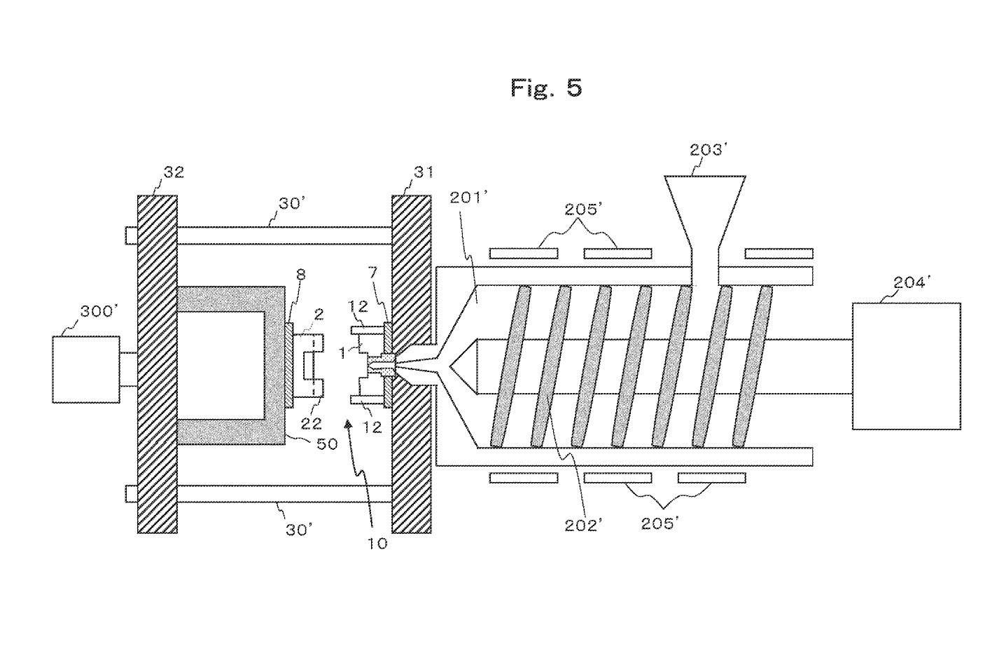

Therefore, an adaptor for attaching the injection mold device 10 to the molding machine may be provided in such a manner that it is possible to exactly use a conventional large-sized molding machine by simply replacing the large-sized metallic mold with the small-sized injection mold device 10. FIG. 5 is a view showing an example of a structure in which the injection mold device 10 according to the present embodiment is attached to the conventional large-sized molding machine by means of the adaptor.

In FIG. 5, referring to components having the same functions as the components shown in FIG. 3 and larger sizes than in FIG. 3, the same reference numerals have a sign “′”. 31 denotes a fixed platen of a molding machine (a plate for attaching a fixing side attaching plate) and 32 denotes a movable platen of the molding machine (a plate for attaching a moving side attaching plate). An attachment position for the arm 9a is placed on the fixed platen 31, which is not shown in FIG. 5.

A tie bar 30′ shown in FIG. 5 has one of end sides fixed to the fixed platen 31 and the other end side inserted in a hole provided on the movable platen 32. The tie bar 30′ serves as a guide for guiding a path for a movement of the moving mold 2 together with a moving side attaching plate 8 and the movable platen 32 in the movement. A hydraulic cylinder 300′ controls the movement of the movable platen 32 (and the moving side attaching plate 8 and the moving mold 2 which are attached thereto).

50 denotes an adaptor which is attached to the movable platen 32 of the molding machine. The moving side attaching place 8 is fixed onto the adaptor 50. The adaptor 50 is a mount to be used for reducing a spatial distance between the fixed mold 1 and the moving mold 2. A shape of the adaptor 50 is optional if a surface to which the moving side attaching plate 8 is to be attached is parallel with the movable platen 32.

In the case in which the large-sized molding machine is used as shown in FIG. 5, a movable range of the movable platen 32 is limited. In other words, when the large-sized metallic mold is attached to the large-sized molding machine, the movable range of the movable platen 32 may be small. In this respect, when the moving side attaching plate 8 is directly attached to the movable platen 32, the moving mold 2 does not reach the fixing mold 1 to bring a state in which mold closing cannot be carried out even if the movable platen 32 is moved maximally in a direction of the fixed mold 1. On the other hand, if the moving side attaching plate 8 is attached by using the adaptor 50, the fixed mold 1 and the moving mold 2 can reliably be closed also in the case in which the large-sized molding machine is used.

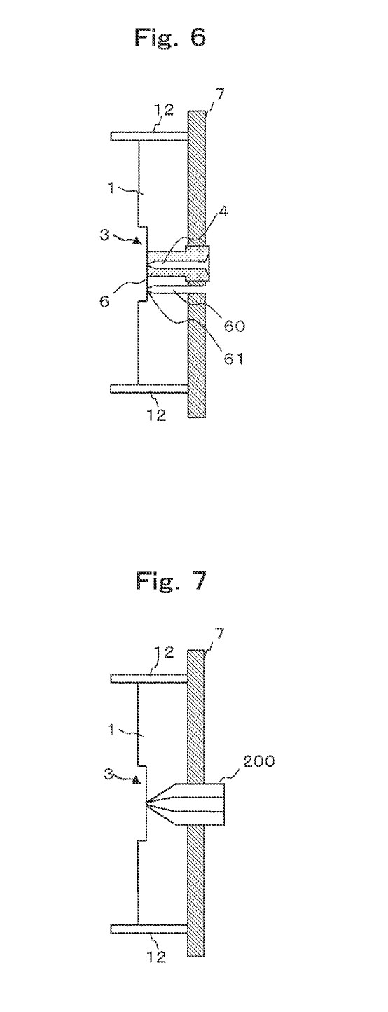

Although the description has been given to the example in which the take-out mechanism 9 is constituted by the arm 9a and the adsorption pad 9b and the molded product is taken out by the vacuum adsorption in the embodiment, moreover, the present invention is not restricted thereto. For example, as shown in FIG. 6, a vent hole 60 penetrating from the molding machine side to the cavity 3 side may be provided on the fixed mold 1 and the fixing side attaching plate 7, and air may be sprayed from the fixing side attaching plate 7 side toward the cavity 3 through the vent hole 60, thereby taking the molded product out at an air pressure thereof. It is preferable to provide a non-return valve 61 on a tip of the vent hole 60 in such a manner that a molten resin does not flow reversely to the vent hole 60.

Although the description has been given to the example in which the fixed mold 1 and the moving mold 2 are constituted by a high heat conductivity material such as a steel material, while the bush 6 is provided around the sprue 4 and is constituted by a low heat conductivity material such as ceramic in the embodiment, moreover, the present invention is not restricted thereto. For example, the fixed mold 1 and the moving mold 2 may be constituted by the low heat conductivity material such as ceramic, while the peripheries of the cavity 3 and the cooling water hole 5 may be constituted by a high heat conductivity material such as a steel material in place of the bush 6 provided around the sprue 4. Thus, the weight of the injection mold device 10 can further be reduced.

Although the description has been given to the example in which the sprue 4 is formed, on the fixed mold 1, as the passage through which the molten resin reaches the cavity 3 in the embodiment, furthermore, the present invention is not restricted thereto. For example, as shown in FIG. 7, a concave portion conforming to a shape of a nozzle 200 of a molding machine may be formed on the fixing mold 1 and a tip of the nozzle 200 may be caused to abut on the cavity 3, thereby setting the nozzle 200 itself as a resin passage. A tip hole of the nozzle 200 is thinned like a gate. In this case, the nozzle 200 is heated by the heater 205. Therefore, a bush formed of ceramic does not need to be provided around the nozzle 200. It is preferable that the heater 205 should be provided in the vicinity of the nozzle 200.

Although the description has been given to the example in which the injection mold device 10 includes the fixing side attaching plate 7 and the moving side attaching plate 8 in the embodiment, moreover, the present invention is not restricted thereto. In other words, the fixing side attaching plate 7 and the moving side attaching plate 8 are not essential structures. For example, as a variant of FIG. 3, a fixed platen and a movable platen in the molding machine may be provided in place of the fixing side attaching plate 7 and the moving side attaching plate 8, and the fixed mold 1 and the moving mold 2 may be directly attached to the fixed platen and the movable platen, respectively. As a variant of FIG. 5, moreover, the fixed mold 1 and the moving mold 2 may directly be attached to the fixed platen 31 of the molding machine and the adaptor 50, respectively.

In addition, the embodiment is only illustrative for materialization in execution of the present invention and the technical scope of the present invention should not be thereby construed to be restrictive. In other words, the present invention can be carried out in various forms without departing from the gist or main features thereof.

1. An injection mold device comprising:
a fixed mold having a first parting surface;
a moving mold including a second parting surface having the same shape and size as the first parting surface;
a cavity formed by providing at least a concave portion on at least one of the first parting surface and the second parting surface; and
at least one of protrusion members in order to position the fixed mold and the moving mold, that is, a first protrusion member which is provided on a side surface of the fixed mold and is protruded toward the moving mold side more greatly than the first parting surface or a second protrusion member which is provided on a side surface of the moving mold and is protruded toward the fixed mold side more greatly than the second parting surface.

2. The injection mold device according to claim 1, wherein
the first protrusion member is provided on the side surface of the fixed mold and is protruded toward the moving mold side more greatly than the first parting surface; and
the second protrusion member is provided on the side surface of the moving mold, that is, a position that is not opposed to the first protrusion member when the fixed mold and the moving mold are closed, and is protruded toward the fixed mold side more greatly than the second parting surface.

3. The injection mold device according to claim 2, wherein shapes of the first parting surface and the second parting surface are square,
the first protrusion member is provided on two side surfaces of the fixed mold which are positioned on opposite sides of the square forming the first parting surface, and
the second protrusion member is provided on opposite sides of the square forming the second parting surface, that is, two side surfaces of the moving mold which are positioned on different opposite sides to the opposite sides where the first protrusion members are provided.

4. The injection mold device according to claim 1, wherein a sprue from a nozzle of a molding machine to the cavity is formed as a passage for a molten resin in the fixed mold.

5. The injection mold device according to claim 1, wherein a concave portion for causing a tip of a nozzle of a molding machine to abut on the cavity is formed in the fixed mold.

6. The injection mold device according to claim 4, wherein the fixed mold and the moving mold are constituted by a high heat conductivity material, while the fixed mold has a bush provided around the sprue and the bush is constituted by a low heat conductivity material.

7. The injection mold device according to claim 4, wherein the fixed mold and the moving mold are constituted by a low heat conductivity material, while the fixed mold has a cooling water hole around the cavity, and peripheries of the cavity and the cooling water hole are constituted by a high heat conductivity material.

8. The injection mold device according to claim 1, further comprising a take-out mechanism for taking out a molded product embracing the cavity of the fixed mold by an adsorption.

9. An injection molding machine obtained by attaching the injection mold device according to claim 1 to a molding machine,
wherein the fixed mold or a fixing side attaching plate having the fixed mold attached thereto is directly attached to a fixed platen of the molding machine, and the moving mold or a moving side attaching plate having the moving mold attached thereto is attached to a movable platen of the molding machine through an adaptor functioning as a mount.

10. The injection mold device according to claim 2, wherein a sprue from a nozzle of a molding machine to the cavity is formed as a passage for a molten resin in the fixed mold.

11. The injection mold device according to claim 3, wherein a sprue from a nozzle of a molding machine to the cavity is formed as a passage for a molten resin in the fixed mold.

12. The injection mold device according to claim 2, wherein a concave portion for causing a tip of a nozzle of a molding machine to abut on the cavity is formed in the fixed mold.

13. The injection mold device according to claim 3, wherein a concave portion for causing a tip of a nozzle of a molding machine to abut on the cavity is formed in the fixed mold.

14. The injection mold device according to claim 2, further comprising a take-out mechanism for taking out a molded product embracing the cavity of the fixed mold by an adsorption.

15. The injection mold device according to claim 3, further comprising a take-out mechanism for taking out a molded product embracing the cavity of the fixed mold by an adsorption.

16. The injection mold device according to claim 4, further comprising a take-out mechanism for taking out a molded product embracing the cavity of the fixed mold by an adsorption.

17. The injection mold device according to claim 5, further comprising a take-out mechanism for taking out a molded product embracing the cavity of the fixed mold by an adsorption.

18. The injection mold device according to claim 6, further comprising a take-out mechanism for taking out a molded product embracing the cavity of the fixed mold by an adsorption.

19. The injection mold device according to claim 7, further comprising a take-out mechanism for taking out a molded product embracing the cavity of the fixed mold by an adsorption.

20. An injection molding machine obtained by attaching the injection mold device according to claim 2 to a molding machine,
wherein the fixed mold or a fixing side attaching plate having the fixed mold attached thereto is directly attached to a fixed platen of the molding machine, and the moving mold or a moving side attaching plate having the moving mold attached thereto is attached to a movable platen of the molding machine through an adaptor functioning as a mount.
